(19) United States
(12) Patent Application Publication
(10) Pub. No.: US 2022/0277600 A1
(43) Pub. Date: Sep. 1, 2022

(54) INSPECTION ASSISTANCE PROGRAM, INSPECTION ASSISTANCE SYSTEM, AND INSPECTION ASSISTANCE METHOD

(71) Applicant: ISUZU MOTORS LIMITED, Tokyo (JP)

(72) Inventor: Masakazu ISHIMARU, Fujisawa-shi, Kanagawa (JP)

(21) Appl. No.: 17/618,340

(22) PCT Filed: Jun. 9, 2020
(86) PCT No.: PCT/JP2020/022660

§ 371 Date: Dec. 10, 2021

(30) Foreign Application Priority Data
Jun. 13, 2019 (JP) 2019-110527

(51) Int. Cl. G07C 5/08; B60W 50/14

(52) U.S. Cl. CPC G07C 5/0816; B60W 50/14; B60W 2050/146

(57) ABSTRACT

A program for supporting inspection of a vehicle causes a computer to function as: a result acquisition unit 255 that acquires an inspection result; a period acquisition unit 253 that acquires a period during which performing of an inspection is unnecessary, in association with each of a plurality of inspection items; and a display control unit 254 that causes a display unit 23 to display a screen for executing an inspection item, the screen being created in a mode determined based on whether a period associated with an inspection item corresponding to the inspection result has elapsed since the result acquisition unit 255 acquired the inspection result.

### TECHNICAL FIELD

The present disclosure relates to an inspection support program, an inspection support system, and an inspection support method for supporting inspection of a vehicle.

### BACKGROUND ART

A user of a commercial vehicle such as a truck needs to perform pre-operation inspection every day. There is known a vehicle inspection support device that displays an input screen for inputting an inspection result of a pre-operation inspection (for example, Patent Literature 1).

### CITATION LIST

### Patent Literature

Patent Literature 1: JP-A-2007-118887

### SUMMARY OF INVENTION

### Technical Problem

In the pre-operation inspection, in addition to an inspection item that is required to be performed every day, there is an inspection item that is not required to be performed every day. However, in the vehicle inspection support device disclosed in Patent Literature 1, there is a problem that a user cannot grasp whether it is time to perform inspection of such an inspection item.

The present disclosure has been made in view of this point, and an object of the present disclosure is to provide an inspection support program, an inspection support system, and an inspection support method that make it possible for a user to grasp whether it is time to perform inspection of an inspection item that is not required to be performed every day.

### Solution to Problem

An inspection support program according to a first aspect of the present disclosure is a program for supporting inspection of a vehicle, the program causing a computer to function as: a result acquisition unit that acquires an inspection result; a period acquisition unit that acquires a period during which performing of an inspection is unnecessary, in association with each of a plurality of inspection items; and a display control unit that causes a display unit to display a screen for executing the inspection item, the screen being created in a mode determined based on whether the period associated with the inspection item corresponding to the inspection result has elapsed since the result acquisition unit acquired the inspection result.

In a case where the period associated with the inspection item corresponding to the inspection result has not elapsed since the result acquisition unit acquired the inspection result, the display control unit may display, in the screen, an operation key for receiving an operation of omitting performing of inspection corresponding to the inspection item.

The computer may be caused to further function as a notification unit that notifies a user of information related to the inspection item in a case where the period associated with the inspection item corresponding to the inspection result has elapsed since the result acquisition unit acquired the inspection result.

The display control unit may display the inspection item in the screen in a case where the period associated with the inspection item corresponding to the inspection result has elapsed since the result acquisition unit acquired the inspection result, and the display control unit may not display the inspection item in the screen in a case where the period associated with the inspection item corresponding to the inspection result has not elapsed since the result acquisition unit acquired the inspection result.

An inspection support system according to a second aspect of the present disclosure is an inspection support system for supporting inspection of a vehicle, the inspection support system including an inspection support device and a management device, in which the inspection support device includes a display unit that displays a screen for executing an inspection item, and the management device includes: a result acquisition unit that acquires an inspection result; a period acquisition unit that acquires a period during which performing of inspection is unnecessary, in association with each of a plurality of inspection items; and a display control unit that causes the display unit to display a screen for executing the inspection item, the screen being created in a mode determined based on whether the period associated with the inspection item corresponding to the inspection result has elapsed since the result acquisition unit acquired the inspection result.

An inspection support method according to a third aspect of the present disclosure is an inspection support method for supporting inspection of a vehicle, the inspection support method including: acquiring an inspection result; acquiring a period during which performing of an inspection is unnecessary, in association with each of a plurality of inspection items; and causing a display unit to display a screen for executing the inspection item, the screen being created in a mode determined based on whether the period associated with the inspection item corresponding to the inspection result has elapsed since the inspection result was acquired.

A storage medium according to a fourth aspect of the present disclosure is a storage medium that stores a computer program for supporting inspection of a vehicle, the computer program, when executed by a computer, causes the computer to execute: acquiring an inspection result; acquiring a period during which performing of an inspection is unnecessary, in association with each of a plurality of inspection items; and causing a display unit to display a screen for executing the inspection item, the screen being created in a mode determined based on whether the period associated with the inspection item corresponding to the inspection result has elapsed since the inspection result was acquired.

In a case where the period associated with the inspection item corresponding to the inspection result has not elapsed since the inspection result was acquired, an operation key for receiving an operation of omitting performing of inspection corresponding to the inspection item may be displayed in the screen.

In a case where the period associated with the inspection item corresponding to the inspection result has elapses since the inspection result was acquired, information related to the inspection item may be notified to a user.

The inspection item may be displayed in the screen in a case where the period associated with the inspection item corresponding to the inspection result has elapsed since the inspection result was acquired, and the inspection item may not be displayed in the screen in a case where the period associated with the inspection item corresponding to the inspection result has not elapsed since the inspection result was acquired.

### Advantageous Effects of Invention

According to the present disclosure, an effect is achieved that it is possible for a user to grasp whether it is time to perform inspection of an inspection item that is not required to be performed every day.

### BRIEF DESCRIPTION OF DRAWINGS

FIG. 1 is a diagram illustrating a configuration of an inspection support system according to an embodiment.

FIG. 2 is a diagram illustrating a screen that is displayed by an inspection support device immediately after an inspection application is started.

FIG. 3 is a diagram illustrating a configuration of a vehicle.

FIG. 4 is a diagram illustrating a configuration of the inspection support device.

FIG. 5A is a diagram illustrating an example of an execution screen created by a display control unit.

FIG. 5B is a diagram illustrating an example of an execution screen created by the display control unit.

FIG. 6 is a diagram illustrating an example of an execution screen displayed by the display control unit.

FIG. 7A is a diagram illustrating an example of a case where the display control unit switches between display and non-display of an inspection item in an execution screen.

FIG. 7B is a diagram illustrating an example of a case where the display control unit switches between display and non-display of an inspection item in an execution screen.

FIG. 8 is a flowchart illustrating a processing procedure of display of an execution screen for executing inspection by the inspection support device.

FIG. 9 is a diagram illustrating a configuration of a management device.

### DESCRIPTION OF EMBODIMENTS

[Overview of Inspection Support System]

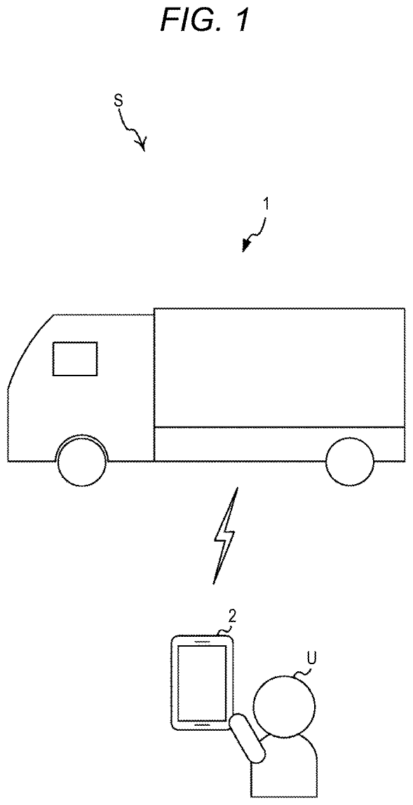

FIG. 1 is a diagram illustrating a configuration of an inspection support system S according to the present embodiment. The inspection support system S includes an inspection support device 2 for supporting inspection of a vehicle 1. The vehicle 1 is a commercial vehicle, and is, for example, a truck. The inspection support device 2 is a device managed by a business operator who inspects the vehicle 1, and is, for example, an information terminal such as a smartphone or a tablet.

The inspection support device 2 displays, on a display, an inspection item and an inspection method for pre-operation inspection of the vehicle 1 when an inspection application software (hereinafter, referred to as an “inspection application”) is started. The inspection support device 2 receives an operation of a user U who inputs an inspection result.

The inspection support device 2 communicates with the vehicle 1 by wireless communication via an in-vehicle wireless device mounted on the vehicle 1. For example, the inspection support device 2 communicates with the vehicle 1 by Wi-Fi (registered trademark) or Bluetooth (registered trademark). The inspection support device 2 transmits, for example, instruction information for changing a state of equipment of the vehicle 1 to the vehicle 1 by wireless communication.

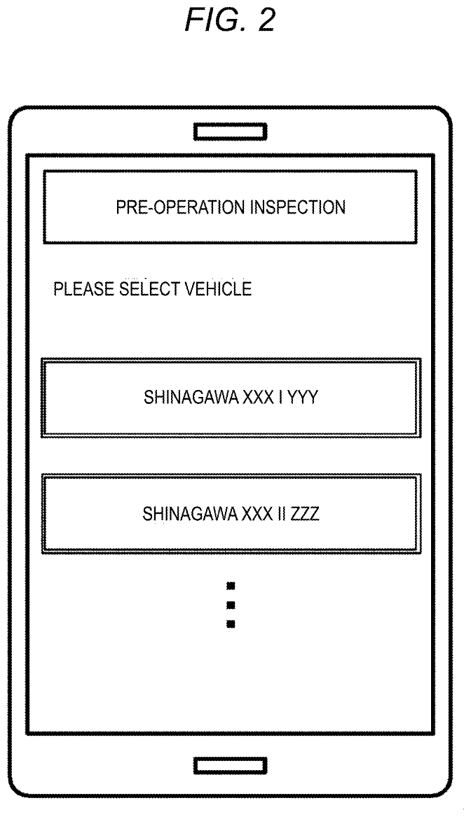

FIG. 2 is a diagram illustrating a screen that is displayed by the inspection support device 2 immediately after the inspection application is started. As illustrated in FIG. 2, the inspection support device 2 first displays a screen for selecting the vehicle 1 that is to be subjected to pre-operation inspection. In the example of FIG. 2, an operation key for selecting a vehicle with vehicle registration information of “Shinagawa XXX I YYY” and an operation key for selecting a vehicle with vehicle registration information of “Shinagawa XXX II ZZZ” are displayed. The vehicle registration information is information for identifying a vehicle. The vehicle registration information is registered in advance by an administrator of the inspection support system S.

When an operation for selecting the vehicle 1 is performed in the screen of FIG. 2, an inspection item necessary for the selected vehicle 1 is displayed. The user U performs inspection corresponding to the displayed inspection item, and inputs an inspection result to the inspection support device 2. Details of a mode in which the inspection support device 2 displays inspection items will be described later.

[Configuration of Vehicle]

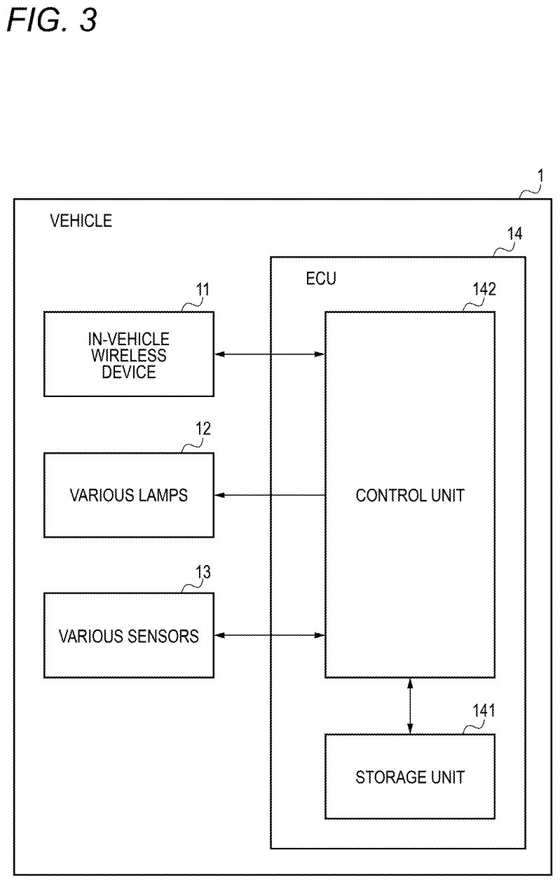

FIG. 3 is a diagram illustrating a configuration of the vehicle 1. The vehicle 1 includes an in-vehicle wireless device 11, various lamps 12, various sensors 13, and an Electronic Control Unit (ECU) 14. The ECU 14 includes a storage unit 141 and a control unit 142.

The in-vehicle wireless device 11 is a device for communicating with the inspection support device 2 by wireless communication. The in-vehicle wireless device 11 transmits information notified from the control unit 142 to the inspection support device 2. In addition, the in-vehicle wireless device 11 notifies the control unit 142 of information received from the inspection support device 2. The in-vehicle wireless device 11 may transmit the information, which is notified from the control unit 142, to a device other than the inspection support device 2 (for example, a server).

The various lamps 12 include, for example, a brake lamp, a backlight, and the like. The various sensors 13 include, for example, a sensor for detecting depression of a brake pedal, a sensor for detecting that a gear is put into reverse, and the like.

The ECU 14 is a control device for electronically controlling each part of the vehicle 1 by a computer. The storage unit 141 includes, for example, a Read Only Memory (ROM), a Random Access Memory (RAM), and the like. The storage unit 141 stores various programs and various types of data for causing the control unit 142 to function.

The control unit 142 controls each part of the vehicle 1 by executing a program stored in the storage unit 141. For example, the control unit 142 turns on or turns off the various lamps 12 in accordance with information received from the inspection support device 2 via the in-vehicle wireless device 11. In addition, the control unit 142 transmits information, which is created based on detection results detected by the various sensors 13, to the inspection support device 2 via the in-vehicle wireless device 11.

[Configuration of Inspection Support Device 2]

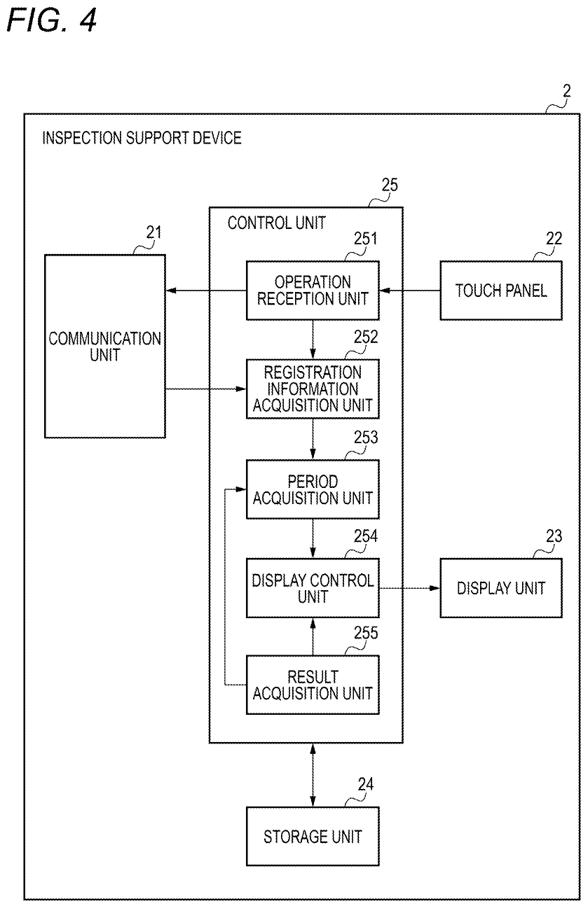

FIG. 4 is a diagram illustrating a configuration of the inspection support device 2. The inspection support device 2 includes a communication unit 21, a touch panel 22, a display unit 23, a storage unit 24, and a control unit 25.

The communication unit 21 is a communication module for communicating with the vehicle 1. The touch panel 22 detects a touch operation on the display unit 23. The display unit 23 is a display for displaying an image. The storage unit 24 includes, for example, a ROM, a RAM, and the like.

The control unit 25 is, for example, a Central Processing Unit (CPU). The control unit 25 functions as an operation reception unit 251, a registration information acquisition unit 252, a period acquisition unit 253, a display control unit 254, and a result acquisition unit 255 by executing a program stored in the storage unit 24.

The operation reception unit 251 receives an operation input to the touch panel 22. The registration information acquisition unit 252 acquires vehicle registration information corresponding to the vehicle 1. For example, the registration information acquisition unit 252 acquires vehicle registration information received by the operation reception unit 251.

The result acquisition unit 255 acquires an inspection result. When the operation reception unit 251 receives an inspection result, the result acquisition unit 255 acquires the inspection result. The result acquisition unit 255 stores the acquired inspection result in the storage unit 24 as history information in association with time information indicating date and time when inspection was performed.

The inspection item includes an inspection item that is required to be performed every day and an inspection item that is not required to be performed every day. In the following description, for the inspection item that is not required to be performed every day, a maximum interval since inspection thereof is performed to a next inspection is referred to as a non-performing period. In the non-performing period, it is not necessary to perform the inspection of the corresponding inspection item. The non-performing period is set for each inspection item. The period acquisition unit 253 refers to a table in the storage unit 24, in which an inspection item and a non-performing period are associated with each other, to acquire non-performing periods in association with each of a plurality of inspection items.

The display control unit 254 determines whether a non-performing period associated with an inspection item corresponding to an inspection result has elapsed since the result acquisition unit 255 acquired the inspection result. Based on the determination result, the display control unit 254 determines a mode of an execution screen for executing the inspection item, and causes the display unit 23 to display the execution screen created in the determined mode.

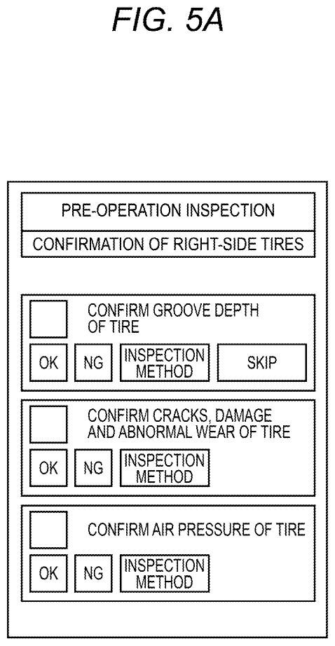

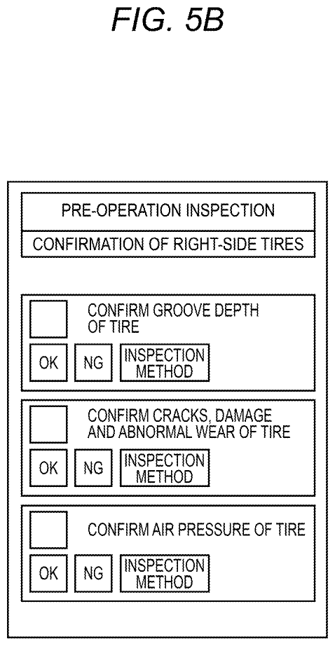

FIGS. 5A and 5B are diagrams illustrating examples of the execution screen created by the display control unit 254. In FIGS. 5A and 5B, a plurality of inspection items are displayed. Among the displayed plurality of inspection items, an inspection item “confirm groove depth of tire” is an inspection item that is not required to be performed every day. An inspection item “confirm cracks, damage and abnormal wear of the tire” and an inspection item “confirm the air pressure of the tire” are inspection items that are required to be performed every day. The display control unit 254 displays the inspection items that are required to be inspected, and thus, occurrence of inspection omission can be prevented.

An “OK” key is an operation key for receiving an operation of inputting that no abnormality is found in the inspection. An “NG” key is an operation key for receiving an operation of inputting that an abnormality is found in the inspection. An “inspection method” key is an operation key for displaying a specific method of inspection or a criterion for determination of an abnormality.

[Display of Skip Key]

In a case where a non-performing period associated with an inspection item corresponding to an inspection result has not elapsed since the result acquisition unit 255 acquired the inspection result, the display control unit 254 displays a predetermined operation key in an execution screen. The predetermined operation key is, for example, a “skip” key for receiving an operation of omitting performing of inspection corresponding to the inspection item.

In the example of FIG. 5A, the non-performing period has not elapsed since the result acquisition unit 255 acquired a previous inspection result of the inspection item “confirm groove depth of tire”. In this case, the display control unit 254 displays the “skip” key in the execution screen. When the user U selects the “skip” key, the user U can view an execution screen including the remaining inspection items without selecting the “OK” key or the “NG” key. That is, the user U can omit performing of inspection of an inspection item corresponding to the skip key.

On the other hand, in a case where the non-performing period associated with an inspection item corresponding to an inspection result has elapsed since the result acquisition unit 255 acquired the inspection result, the display control unit 254 does not display the predetermined operation key in the execution screen. In the example of FIG. 51, the non-performing period has elapsed since the result acquisition unit 255 acquired the previous inspection result of the inspection item “confirm groove depth of tire”. In this case, the display control unit 254 does not display the “skip” key in the execution screen.

In a state where the “skip” key is not displayed in the execution screen, the display control unit 254 does not display the execution screen of the remaining inspection items until the “OK” key or the “NG” key is selected by the user U with respect to the inspection item “confirm groove depth of tire”. That is, the user U cannot omit performing of inspection of an inspection item for which the skip key is not displayed.

[Notification of Elapse of Non-Performing Period]

In addition, the display control unit 254 may function as a notification unit that, in a case where a non-performing period associated with an inspection item corresponding to an inspection result has elapsed since the result acquisition unit 255 acquired the inspection result, notifies the user U of information related to the inspection item. The information related to the inspection item is, for example, information indicating the number of days elapsed since a previous performing of the inspection item. On the other hand, in a case where the non-performing period associated with an inspection item corresponding to an inspection result has not elapsed since the result acquisition unit 255 acquired the inspection result, the display control unit 254 does not notify the user U of the information related to the inspection item.

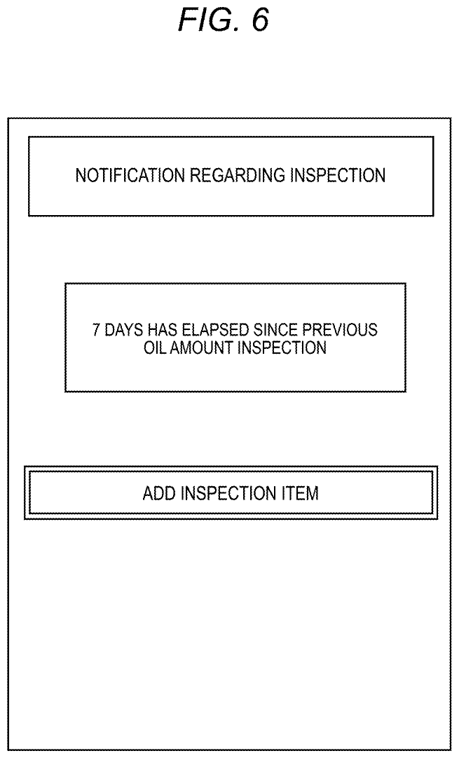

FIG. 6 is a diagram illustrating an example of an execution screen displayed by the display control unit 254. In the state of FIG. 6, a non-performing period associated with an inspection item “oil amount inspection” has elapsed since the result acquisition unit 255 acquired an inspection result of the inspection item. In this case, as illustrated in FIG. 6, the display control unit 254 displays a screen for notifying the user U of a period (7 days) elapsed since a previous performing of inspection of the inspection item. With such a configuration, the display control unit 254 can notify the user U of an inspection item whose non-performing period has elapsed.

[Non-Display of Inspection Item]

The operation of the display control unit 254 is not limited to the example in which the “skip” key is displayed in a case where the non-performing period has not elapsed. The display control unit 254 may display only an inspection item whose corresponding non-performing period has elapsed in the execution screen.

The display control unit 254 determines whether the non-performing period associated with the inspection item corresponding to the inspection result has elapsed since the result acquisition unit 255 acquired the inspection result. In a case where it is determined that the non-performing period has not elapsed, the display control unit 254 may not display the inspection item in the execution screen. On the other hand, in a case where it is determined that the non-performing period has elapsed, the display control unit 254 displays the inspection item in the execution screen.

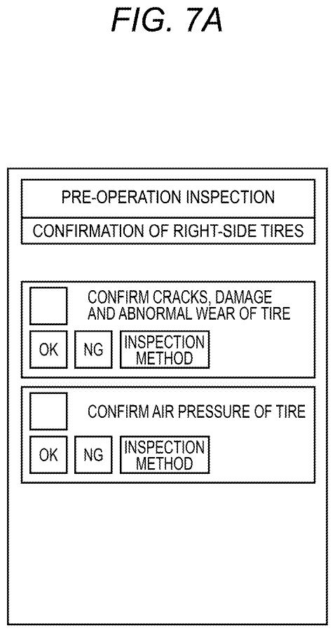

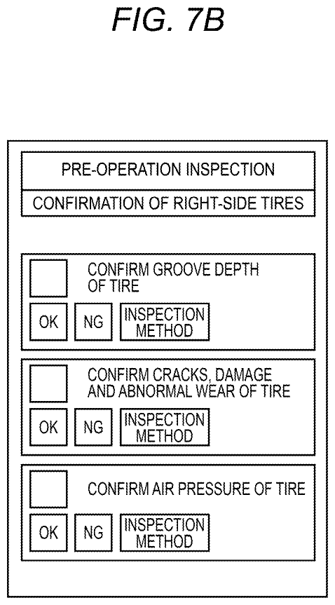

FIG. 7A and FIG. 7B are diagrams illustrating an example in which the display control unit 254 switches between display and non-display of an inspection item in an execution screen. In the state illustrated in FIG. 7A, a non-performing period associated with an inspection item “confirm groove depth of tire” has not elapsed since the result acquisition unit 255 acquired an inspection result of the inspection item. In this case, the display control unit 254 does not display the inspection item “confirm groove depth of tire”.

In the state illustrated in FIG. 7B, the non-performing period associated with the inspection item “confirm groove depth of tire” has elapsed since the result acquisition unit 255 acquired the inspection result of the inspection item. In this case, as illustrated in FIG. 7B, the display control unit 254 displays the inspection item “confirm groove depth of tire”.

[Processing Procedure of Display of Execution Screen]

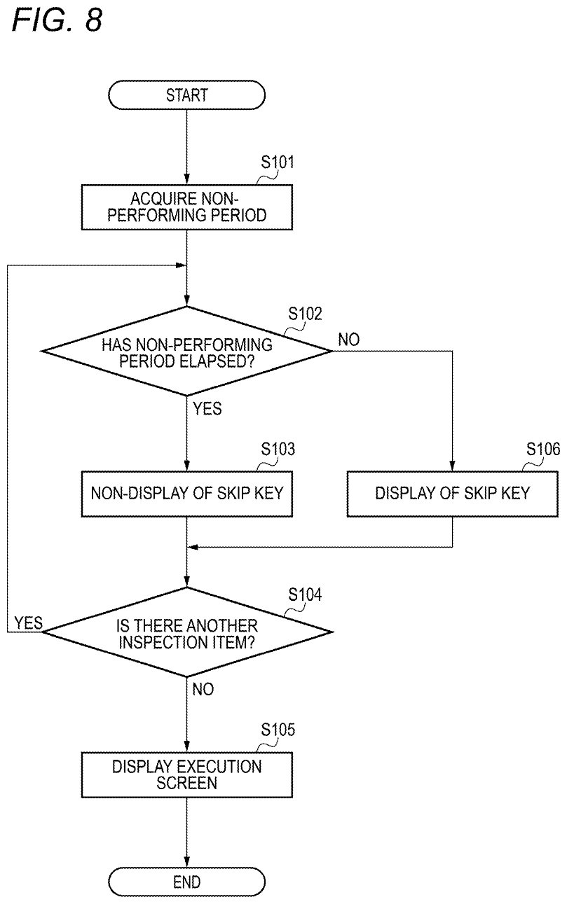

FIG. 8 is a flowchart illustrating a processing procedure of display of an execution screen for executing inspection by the inspection support device 2. This processing procedure is started, for example, when the operation reception unit 251 receives an instruction of the user U to display an execution screen.

First, the period acquisition unit 253 reads, from the storage unit 24, a table in which an inspection item and a non-performing period during which performing of inspection is unnecessary are associated with each other. The period acquisition unit 253 refers to the read table to acquire a non-performing period associated with an inspection item displayed in the execution screen (S101). The display control unit 254 determines whether the non-performing period associated with the inspection item has elapsed since the result acquisition unit 255 acquired a previous inspection result of the displayed inspection item (S102).

In a case where it is determined that the non-performing period associated with the inspection item has elapsed (YES in S102), the display control unit 254 determines a mode of the execution screen so that a skip key corresponding to the inspection item is not displayed in the execution screen (S103).

The display control unit 254 determines whether there is another inspection item displayed in the execution screen (S104). In a case where there is no other inspection item displayed in the execution screen (NO in S104), the display control unit 254 displays the execution screen on the display unit 23 and ends the processing.

In a case where it is determined that the non-performing period associated with the inspection item has not elapsed in the determination of S102 (NO in S102), the display control unit 254 determines a mode of the execution screen so that the skip key corresponding to the inspection item is displayed in the execution screen (S106), and proceeds to the determination of S104. Ina case where it is determined that there is another inspection item displayed in the execution screen in the determination of S104 (YES in S104), the display control unit 254 returns to the determination of S102.

[Effects of Present Disclosure]

According to the present embodiment, the display control unit 254 determines a mode of an execution screen based on whether a non-performing period associated with an inspection item has elapsed. With such a configuration, it is possible for a user to grasp whether it is time to perform inspection of an inspection item that is not required to be performed every day.

[Management Device]

The inspection support system S may further include a management device 3 connected to the inspection support device 2 via a wireless communication line. The inspection support device 2 may include a communication control unit (not illustrated) that transmits vehicle registration information of the vehicle 1 to be inspected and an inspection result received by the operation reception unit 251 to the management device 3.

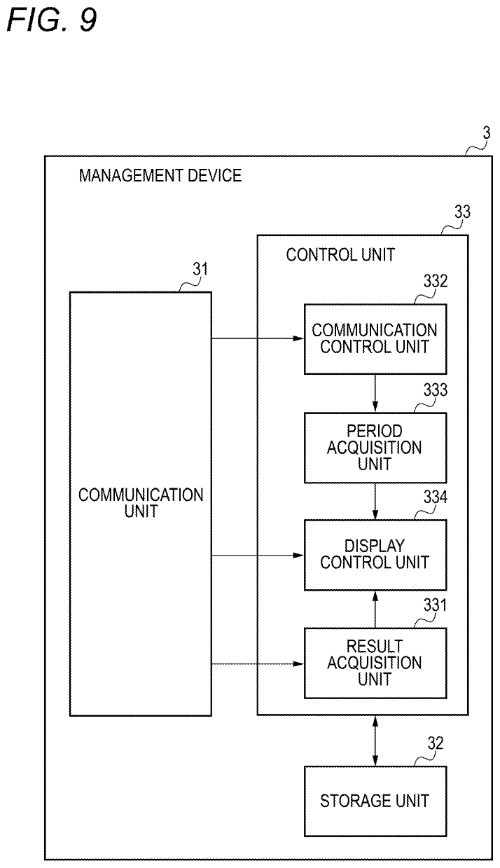

FIG. 9 is a diagram illustrating a configuration of the management device 3. The management device 3 includes a communication unit 31, a storage unit 32, and a control unit 33. The communication unit 31 is an interface for communicating with the inspection support device 2. The storage unit 32 is configured with, for example, a ROM, a RAM, and the like. The storage unit 32 stores various programs and various types of data for causing the control unit 33 to function.

The control unit 33 is, for example, a CPU. The control unit 33 functions as a result acquisition unit 331, a communication control unit 332, a period acquisition unit 333, and a display control unit 334 by executing a program stored in the storage unit 32. The result acquisition unit 331 acquires an inspection result and time information indicating date and time when inspection corresponding to the inspection result is performed, from the inspection support device 2 via the communication unit 31. The result acquisition unit 331 stores the acquired inspection result and time information in the storage unit 32 as history information in association with each other.

The communication control unit 332 receives vehicle registration information via the communication unit 31. The period acquisition unit 333 identifies a plurality of inspection items to be displayed in an execution screen of the inspection support device 2 based on the received vehicle registration information. The period acquisition unit 333 reads a table, in which an inspection item and a non-performing period are associated with each other, from the storage unit 32, refers to the table, and acquires non-performing periods in association with each of the plurality of inspection items to be displayed.

The display control unit 334 determines whether a non-performing period associated with an inspection item corresponding to an inspection result has elapsed since the result acquisition unit 331 acquired the inspection result. The display control unit 334 determines a mode of an execution screen for executing the inspection item based on a determination result. The display control unit 334 transmits the execution screen created in the determined mode to the inspection support device 2 and instructs the display unit 23 of the inspection support device 2 to display the execution screen.

With such a configuration, the management device 3 can manage inspection results of a plurality of vehicles 1 in central control. Therefore, in a business office or the like where a plurality of users U use a plurality of vehicles 1, the inspection results can be shared between the users U.

Although the present disclosure has been described above using the embodiment, the technical scope of the present disclosure is not limited to the scope described in the above embodiment, and various modifications and changes can be made within the scope of the spirit of the present disclosure. For example, all or some of the devices may be functionally or physically distributed or integrated in any unit. Further, a new embodiment generated by any combination of a plurality of embodiments is also contained in the embodiment of the present disclosure. Effects of the new embodiment generated by the combination include effects of the original embodiment.

The present application is based on the Japanese Patent Application No. 2019-110527 filed on Jun. 13, 2019, and contents thereof are incorporated herein as reference.

### INDUSTRIAL APPLICABILITY

The inspection support program, the inspection support system, and the inspection support method of the present disclosure are useful in that a user can grasp whether it is time to perform inspection of an inspection item that is not required to be performed every day.

### REFERENCE SIGNS LIST

1 vehicle
2 inspection support device
3 management device
1I in-vehicle wireless device
12 various lamps
13 various sensors
14 ECU
21 communication unit
22 touch panel
23 display unit
24 storage unit
control unit
31 communication unit
32 storage unit
33 control unit
141 storage unit
142 control unit
251 operation reception unit
252 registration information acquisition unit
253 period acquisition unit
254 display control unit
255 result acquisition unit
331 result acquisition unit
332 communication control unit
333 period acquisition unit
334 display control unit

1. A storage medium that stores a computer program for supporting inspection of a vehicle, the computer program, when executed by a computer, causes the computer to execute:
acquiring an inspection result;
acquiring a period during which performing of an inspection is unnecessary, in association with each of a plurality of inspection items; and
causing a display unit to display a screen for executing the inspection item, the screen being created in a mode determined based on whether the period associated with the inspection item corresponding to the inspection result has elapsed since the inspection result was acquired.

2. The storage medium according to claim 1,
wherein in a case where the period associated with the inspection item corresponding to the inspection result has not elapsed since the inspection result was acquired, an operation key for receiving an operation of omitting performing of inspection corresponding to the inspection item is displayed in the screen.

3. The storage medium according to claim 1, further causing the computer to execute:
notifying a user of information related to the inspection item in a case where the period associated with the inspection item corresponding to the inspection result has elapsed since the inspection result was acquired.

4. The storage medium according to claim 1,
wherein the inspection item is displayed in the screen in a case where the period associated with the inspection item corresponding to the inspection result has elapsed since the inspection result was acquired, and the inspection item is not displayed in the screen in a case where the period associated with the inspection item corresponding to the inspection result has not elapsed since the inspection result was acquired.

5. An inspection support system for supporting inspection of a vehicle, the inspection support system comprising:
an inspection support device; and
a management device,
wherein the inspection support device includes a display unit that displays a screen for executing an inspection item, and
wherein the management device includes:
a result acquisition unit that acquires an inspection result;
a period acquisition unit that acquires a period during which performing of an inspection is unnecessary, in association with each of a plurality of inspection items; and
a display control unit that causes the display unit to display a screen for executing the inspection item, the screen being created in a mode determined based on whether the period associated with the inspection item corresponding to the inspection result has elapsed since the result acquisition unit acquired the inspection result.

6. An inspection support method for supporting inspection of a vehicle, the inspection support method comprising:
acquiring an inspection result;
acquiring a period during which performing of an inspection is unnecessary, in association with each of a plurality of inspection items; and
causing a display unit to display a screen for executing the inspection item, the screen being created in a mode determined based on whether the period associated with the inspection item corresponding to the inspection result has elapsed since the inspection result was acquired.
